(19) United States
(12) Patent Application Publication
(10) Pub. No.: US 2015/0302487 A1
(43) Pub. Date: Oct. 22, 2015

(54) METHOD AND ARRANGEMENT FOR PROVIDING ADAPTIVE BITRATE-DYNAMIC ADVERTISEMENTS

(71) Applicant: ERICSSON TELEVISION INC., Duluth, GA (US)

(72) Inventor: Jennifer Ann Reynolds, Duluth, GA (US)

(73) Assignee: ERICSSON TELEVISION INC., Duluth, GA (US)

(21) Appl. No.: 14/255,029

(22) Filed: Apr. 17, 2014

(51) Int. Cl. G06Q 30/02; H04L 29/06

(52) U.S. Cl. CPC G06Q 30/0277; H04L 65/60

(57) ABSTRACT

A method and arrangement in an advertisement control system for providing adaptive bitrate-dynamic advertisements in an adaptively streamed video stream defined by a manifest. A bitrate monitor monitors the varying delivery bitrate of the video stream. A processor determines whether the delivery bitrate has fallen below a minimum bitrate threshold of a next advertisement in the manifest. If so, the arrangement replaces the next advertisement with a replacement video chunk such as a replacement advertisement having a minimum bitrate threshold lower than or equal to the delivery bitrate of the video stream. The arrangement may be implemented in an advertisement server, a client device, or a manifest creator.

### TECHNICAL FIELD

The present disclosure relates generally to communication systems and more particularly to a method and arrangement for providing adaptive bitrate-dynamic advertisements in a video stream.

### BACKGROUND

Adaptive bitrate streaming modifies the quality of a given video to best suit changing network conditions. Utilizing adaptive bitrate streaming enables a client to choose between various available bitrates based on the changing network conditions. When network conditions deteriorate, a lower bitrate is selected. This causes a corresponding drop in video quality without stopping the video playback. Various methods of modifying an adaptive bitrate stream currently exist.

### SUMMARY

The lowered video quality resulting from existing methods of adaptive bitrate streaming results in less distinct visuals, which can cause difficulty seeing small visual elements or reading small text. Some advertisements are designed with small visual elements, or with an emphasis on quality which is negatively impacted by low bitrates. The current methods of varying the video quality of a streaming video can render advertisements that require high video quality ineffective when an adaptive streaming method lowers the bitrate.

It is an object of the present disclosure to mitigate this problem through a method and arrangement that exchanges advertisements having different quality requirements based on current network conditions. Before instructing a video player to play an advertisement, the apparatus checks the network quality to confirm the minimum bitrate requirement of the advertisement is met. If not, the advertisement is removed (for example, to be played later when network quality improves) and replaced with a video chunk whose minimum bitrate requirement has been met. The video chunk may be, for example, a second, “backup” advertisement for the same product or service with larger text or less graphical detail, may be an advertisement for a different product or service, or may be a non-advertisement video that fits within the scheduled advertisement slot.

A first embodiment provides a method in an advertisement control system for providing adaptive bitrate-dynamic advertisements in a video stream defined by a manifest, wherein adaptive streaming in a delivery network causes a delivery bitrate of the video stream to vary due to changes in delivery network conditions. The method includes monitoring the delivery bitrate of the video stream in the delivery network; determining whether the delivery bitrate of the video stream has fallen below a minimum bitrate threshold of a next advertisement in the manifest; and when the delivery bitrate of the video stream has fallen below the minimum bitrate threshold of the next advertisement, replacing the next advertisement in the manifest with a replacement video chunk having a minimum bitrate threshold lower than or equal to the delivery bitrate of the video stream.

In one exemplary embodiment, the method is performed by an advertisement server, and the server determines the minimum bitrate threshold of the next advertisement by reading metadata included with the next advertisement. In a further embodiment, the replacement video chunk is a replacement advertisement, and upon determining that the delivery bitrate of the video stream has fallen below the minimum bitrate threshold of the next advertisement, the advertisement server attempts to identify a replacement advertisement having a minimum bitrate threshold lower than or equal to the delivery bitrate of the video stream. When a replacement advertisement having a minimum bitrate threshold lower than or equal to the delivery bitrate of the video stream cannot be identified, the server streams the next advertisement to a client device. When a replacement advertisement having a minimum bitrate threshold lower than or equal to the delivery bitrate of the video stream can be identified, the server performs the replacing step with the identified replacement advertisement.

In another exemplary embodiment, the method is performed by a client device and the client device determines the minimum bitrate threshold of the next advertisement by reading metadata included with the next advertisement. In a further embodiment, the client device retrieves the replacement video chunk from a local memory in the client device. Since this video chunk is not impacted by network conditions, the client device may select a video chunk having a bitrate profile of similar quality to the delivery bitrate for consistency of viewing by an end user.

In another exemplary embodiment, the method is performed by a manifest creator, and the manifest creator determines the minimum bitrate threshold of the next advertisement by reading metadata included with the next advertisement. In a further embodiment, the manifest creator obtains advertisements from a plurality of advertisement sources, each advertisement source providing advertisements with different minimum bitrate thresholds. When the delivery bitrate of the video stream has fallen below the minimum bitrate threshold of a next advertisement provided by a first advertisement source, the manifest creator selects a different, second advertisement source that provides advertisements with a lower minimum bitrate threshold than the first advertisement source; obtains a replacement advertisement from the second advertisement source; and replaces the next advertisement in the manifest with the replacement advertisement from the second advertisement source when the replacement advertisement has a minimum bitrate threshold lower than or equal to the delivery bitrate of the video stream.

Another exemplary embodiment provides an arrangement in an advertisement control system for providing adaptive bitrate-dynamic advertisements in a video stream defined by a manifest, wherein adaptive streaming in a delivery network causes a delivery bitrate of the video stream to vary due to changes in delivery network conditions. The arrangement includes a bitrate monitor configured to monitor the delivery bitrate of the video stream; and a processor configured to determine whether the delivery bitrate of the video stream has fallen below a minimum bitrate threshold of a next advertisement in the manifest, and replace the next advertisement in the manifest with a replacement video chunk when the delivery bitrate of the video stream has fallen below the minimum bitrate threshold of the next advertisement, wherein the replacement video chunk has a minimum bitrate threshold lower than or equal to the delivery bitrate of the video stream.

In various embodiments of the arrangement, the arrangement may be implemented in an advertisement server, a client device, or a manifest creator.

The present invention also concerns computer programs comprising portions of software codes in order to implement the method as described above when operated by a respective processing unit of an advertisement server, a client device, or a manifest creator. The computer program is stored on a non-transitory computer-readable medium. The computer-readable medium may be a permanent or rewritable memory within the server, client device, or manifest creator, or may be located externally.

Further features and benefits of embodiments of the disclosure will become apparent from the detailed description below.

### BRIEF DESCRIPTION OF THE DRAWINGS

In the following section, the invention will be described with reference to exemplary embodiments illustrated in the figures, in which:

FIG. 1 is a simplified block diagram of an exemplary advertisement control system suitable for implementing embodiments of the present disclosure;

FIG. 2 is a flow chart illustrating the steps of a method performed by an advertisement server in a first exemplary embodiment of the present disclosure;

FIG. 3 is a simplified block diagram of an exemplary advertisement server configured to perform the method of FIG. 2;

FIG. 4 is a flow chart illustrating the steps of a method performed by a client device in a second exemplary embodiment of the present disclosure;

FIG. 5 is a simplified block diagram of an exemplary client device configured to perform the method of FIG. 4;

FIG. 6 is a flow chart illustrating the steps of a method performed by a manifest creator in a third exemplary embodiment of the present disclosure; and

FIG. 7 is a simplified block diagram of an exemplary manifest creator configured to perform the method of FIG. 6.

### DETAILED DESCRIPTION

The present disclosure will now be described more fully with reference to the accompanying drawings, in which preferred embodiments of the disclosure are shown. In the below, for purposes of explanation and not limitation, specific details are set forth in order to provide a thorough understanding of the present invention. It will be apparent to one skilled in the art that the present invention may be practiced in other embodiments that depart from these specific details.

Those skilled in the art will further appreciate that the functions explained below may be implemented using hardware circuitry, computer software, or a combination thereof. The software may be executed by a programmed microprocessor or a general purpose computer, using an Application Specific Integrated Circuit (ASIC) and/or Digital Signal Processors (DSPs). It will also be apparent that when the present invention is described as a method, it may also be embodied in a computer processor and a non-transitory memory coupled to the processor, wherein the memory is encoded with one or more programs that perform the method when executed by the processor.

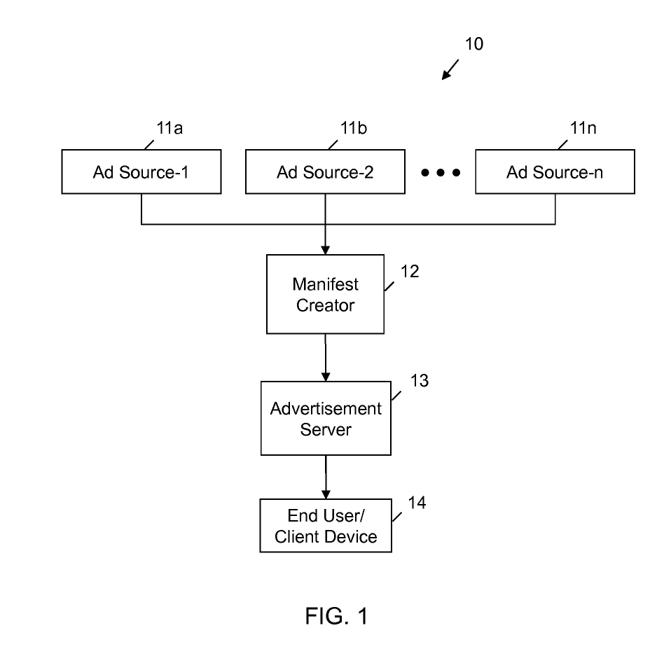

FIG. 1 is a simplified block diagram of an exemplary advertisement control system 10 suitable for implementing embodiments of the present disclosure. A number of advertising content sources 11a-11n may provide advertisements to a manifest creator 12. The manifest creator provides a manifest of video content to an advertisement server 13. The advertisement server determines suitable advertisements to insert into advertisement slots in the manifest and streams the advertisements to end user devices such as client device 14. The advertisements and other video content may be distributed over a wireline content distribution network (not shown) or through a wireless telecommunication network to the client device 14.

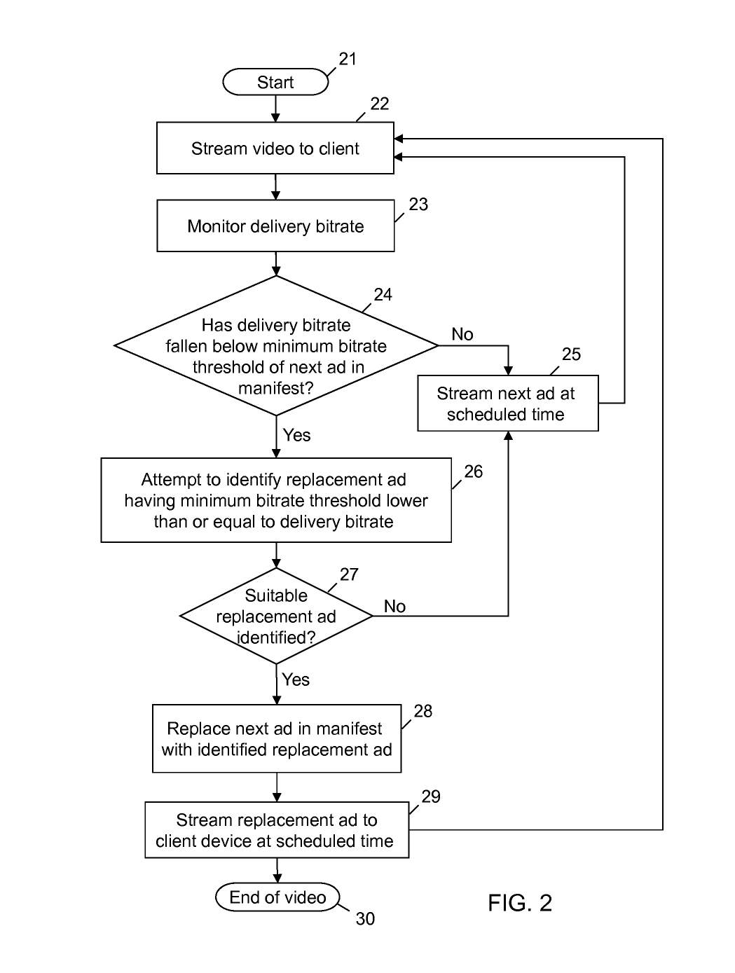

FIG. 2 is a flow chart illustrating the steps of a method performed by the advertisement server 13 in a first exemplary embodiment of the present disclosure. The method starts at step 21 and moves to step 22 where the server streams video content to the client device 14. At step 23, the delivery bitrate of the video stream is monitored. At step 24, it is determined whether the delivery bitrate has fallen below a minimum bitrate threshold for a next advertisement in the manifest. In one embodiment, advertisements may be marked (for example, by the content provider or manifest creator) with an indication of the minimum bitrate threshold. The indication may be included, for example, in metadata in the advertisement, and the server may determine the threshold by reading the metadata prior to streaming the advertisement to the client device. When the delivery bitrate has not fallen below the minimum bitrate threshold for the next advertisement, the method moves to step 25 where the server streams the next advertisement at the scheduled time. The method then returns to step 22 and continues to stream the video and monitor the delivery bitrate at step 23.

However, when it is determined at step 24 that the delivery bitrate has fallen below the minimum bitrate threshold for the next advertisement in the manifest, the method moves to step 26 where the advertisement server attempts to identify a replacement video chunk such as a replacement advertisement having a minimum bitrate threshold lower than or equal to the current delivery bitrate. The server may give preference to advertisements for the same product that perform better at lower bitrates. At step 27 it is determined whether a suitable replacement advertisement has been identified. If not, the method returns to step 25 and streams the next advertisement at the scheduled time even though the delivery bitrate is below the minimum bitrate threshold of the next advertisement. The method then returns to step 22 and continues to stream the video and monitor the delivery bitrate at step 23.

However, when it is determined at step 24 that a suitable replacement advertisement has been identified, the method moves to step 28 where the advertisement server “replaces” the next advertisement in the manifest with the identified replacement advertisement. This may be accomplished without changing the manifest itself, but by changing the reference for the next advertisement to point to a different video asset. At step 29, the advertisement server streams the identified replacement advertisement to the client device 14 at the scheduled time. The method then returns to step 22 and continues to stream the video and monitor the delivery bitrate at step 23. The method ends when the video ends at step 30.

This embodiment of the method of controlling advertisements is invisible to the client device 14 and the end user. This allows for dynamic advertisement replacement which can provide extra levels of customizability.

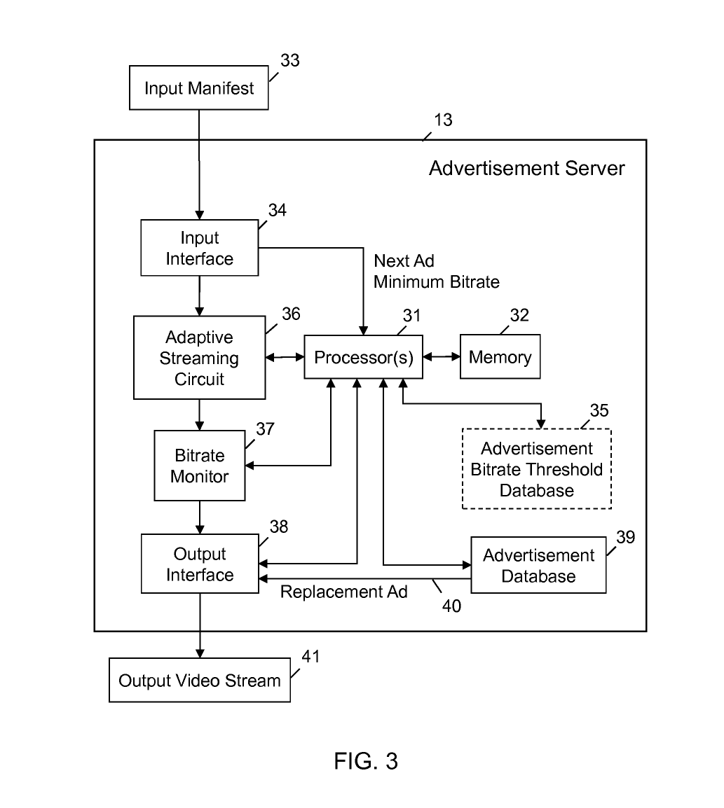

FIG. 3 is a simplified block diagram of an exemplary advertisement server 13 configured to perform the method of FIG. 2. The server may be controlled by one or more computer processor(s) 31 and a non-transitory memory 32 coupled to the processor, wherein the memory is encoded with one or more programs that perform the method when executed by the processor. An input manifest 33 is received by an input interface 34. The minimum bitrate threshold for the next advertisement may be read by the input interface and sent to the processor 31. Alternatively, minimum bitrate information for the advertisements in the manifest may be stored in an advertisement bitrate threshold database 35 and read by the processor when needed.

An adaptive streaming circuit 36 varies the delivery bitrate of the video stream based on current network conditions. A bitrate monitor 37 monitors the current delivery bitrate and reports it to the processor 31. The processor determines whether the delivery bitrate has fallen below the minimum bitrate threshold for the next advertisement and takes appropriate action. When the delivery bitrate has not fallen below the minimum bitrate threshold for the next advertisement, the processor controls an output interface 39 to stream the next advertisement at the scheduled time. When the delivery bitrate has not fallen below the minimum bitrate threshold for the next advertisement, the processor searches an advertisement database 39 in an attempt to identify a suitable replacement advertisement for which the current delivery bitrate is above the minimum bitrate threshold. When a suitable replacement advertisement 40 is identified, the processor instructs the output interface 38 to stream the replacement advertisement. The replacement advertisement is then streamed in the output video stream 41 at the scheduled time.

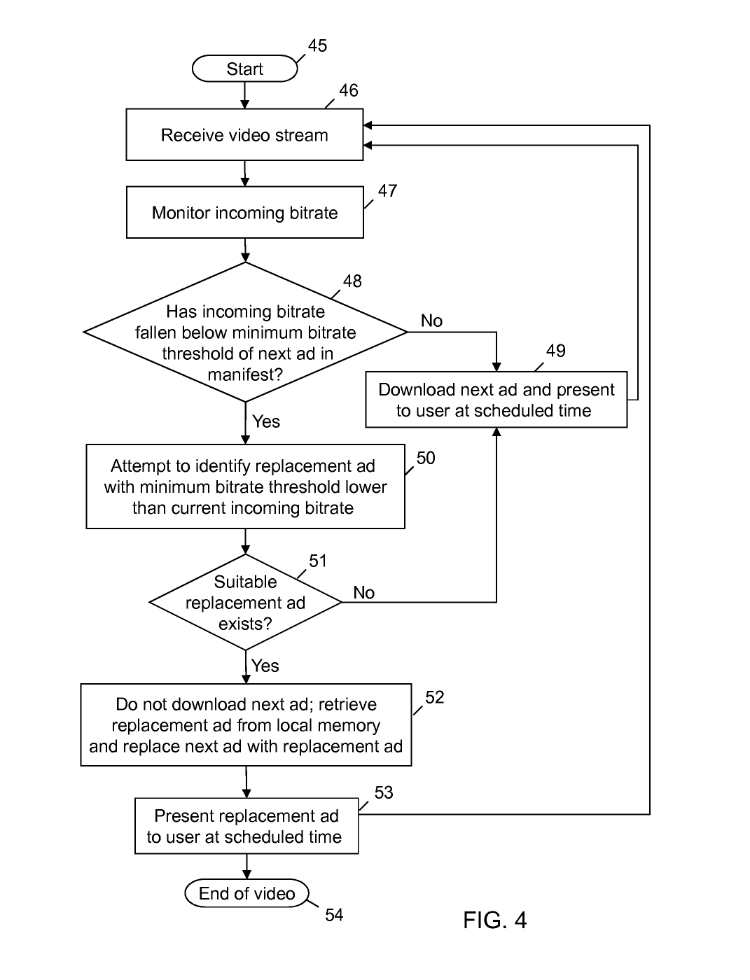

FIG. 4 is a flow chart illustrating the steps of a method performed by the client device 14 in a second exemplary embodiment of the present disclosure. In this embodiment, appropriate replacement video chunks such as replacement advertisements are stored on the client device itself. The method starts at step 45 and moves to step 46 where the client device receives the video stream from the server 13. At step 47, the incoming bitrate of the video stream is monitored. At step 48, it is determined whether the incoming bitrate has fallen below a minimum bitrate threshold for a next advertisement in the manifest. In one embodiment, advertisements may be marked (for example, by the content provider or manifest creator) with an indication of the minimum bitrate threshold. The indication may be included, for example, in metadata in the advertisement, and the client device may determine the threshold by reading the metadata prior to downloading the complete advertisement and presenting the advertisement to the end user. When the incoming bitrate has not fallen below the minimum bitrate threshold for the next advertisement, the method moves to step 49 where the client device downloads the next advertisement and presents it to the end user at the scheduled time. The method then returns to step 46 and continues to receive the video stream and monitor the incoming bitrate at step 47.

However, when it is determined at step 48 that the incoming bitrate has fallen below the minimum bitrate threshold for the next advertisement in the manifest, the method moves to step 50 where the client device attempts to identify a replacement video chunk such as a replacement advertisement. Since the replacement advertisement is stored on the client device itself, network conditions do not affect the bitrate at which the replacement advertisement can be presented. Therefore, the client device may present the replacement advertisement at a bitrate greater than, equal to, or less than the current incoming bitrate of the video stream. For example, the client device may present the replacement advertisement at a bitrate and quality comparable to the video stream the end user was watching for consistency of presentation. Alternatively, the client device may choose to present the replacement advertisement at a higher bitrate and improved quality. If the client device has noted a downward trend in the incoming bitrate of the video stream, the replacement advertisement may be presented at a bitrate lower than the current incoming bitrate in anticipation of the incoming bitrate being lower when the replacement advertisement ends. At step 51 it is determined whether a suitable replacement advertisement has been identified. If not, the method returns to step 49 and downloads the next advertisement and presents it to the end user at the scheduled time. The method then returns to step 46 and continues to receive the video stream and monitor the incoming bitrate at step 47.

However, when it is determined at step 51 that a suitable replacement advertisement has been identified, the method moves to step 52 where the client device does not download the next advertisement in the manifest and, instead, replaces it with the identified replacement advertisement. This may be accomplished without changing the manifest itself, but by accessing an internal advertisement database and retrieving the identified replacement advertisement. At step 53, the client device presents the identified replacement advertisement to the end user at the scheduled time. The method then returns to step 46 and continues to receive the video stream and monitor the incoming bitrate at step 47. The method ends when the video ends at step 54.

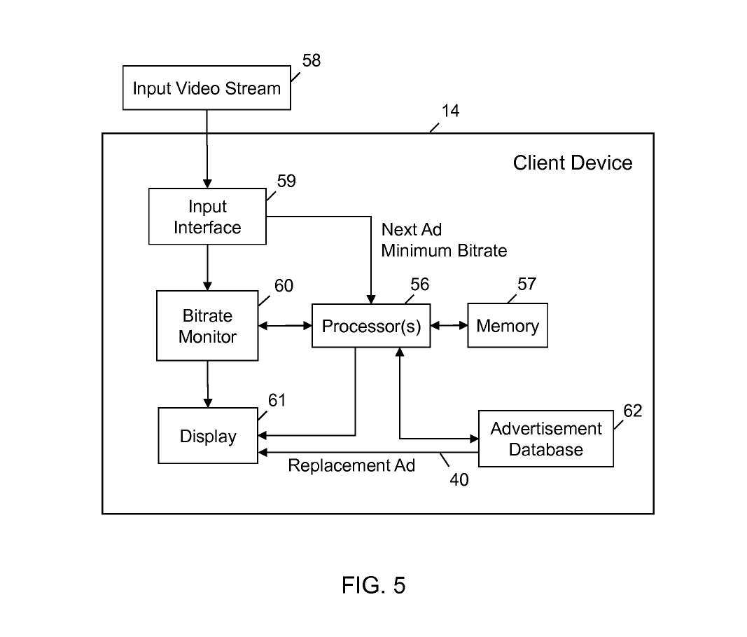

FIG. 5 is a simplified block diagram of an exemplary client device 14 configured to perform the method of FIG. 4. The client device may be controlled by one or more computer processor(s) 56 and a non-transitory memory 57 coupled to the processor, wherein the memory is encoded with one or more programs that perform the method when executed by the processor. An input video stream 58 is received by an input interface 59. The minimum bitrate threshold for the next advertisement may be read by the input interface and sent to the processor 56.

A bitrate monitor 60 monitors the current incoming bitrate and reports it to the processor 56. The processor determines whether the delivery bitrate has fallen below the minimum bitrate threshold for the next advertisement and takes appropriate action. When the delivery bitrate has not fallen below the minimum bitrate threshold for the next advertisement, the processor controls an output circuit to present the next advertisement on a display 61 at the scheduled time. When the delivery bitrate has not fallen below the minimum bitrate threshold for the next advertisement, the processor searches an advertisement database 62 in an attempt to identify a suitable replacement advertisement. When a suitable replacement advertisement 40 is identified, the processor causes the replacement advertisement to be presented on the display at the scheduled time. As noted above, since network conditions do not affect the bitrate at which the replacement advertisement can be presented, the processor may cause the replacement advertisement to be presented at a bitrate greater than, equal to, or less than the current incoming bitrate of the video stream.

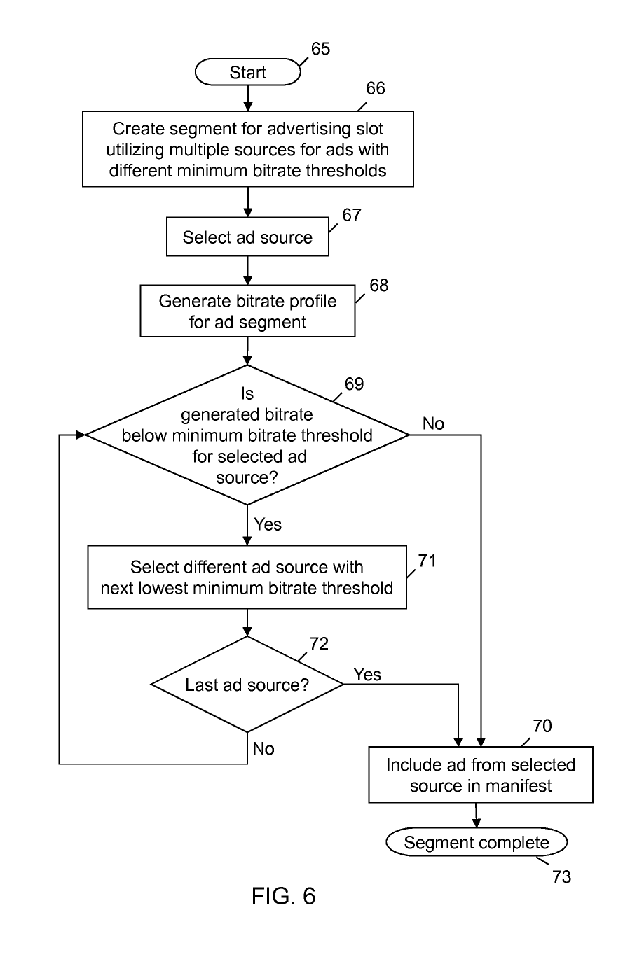

FIG. 6 is a flow chart illustrating the steps of a method performed by the manifest creator 12 in a third exemplary embodiment of the present disclosure. In this embodiment, the manifest creator 12 uses multiple advertisement sources 11a-11n (FIG. 1) to create bitrates and segments for a single advertising slot. The method starts at step 65 and moves to step 66 where the manifest creator creates a segment for an advertising slot utilizing the multiple sources 11a-11n, each of which provides an advertisement with a different minimum bitrate threshold. At step 67, the manifest creator selects one of the advertisement sources, and generates a bitrate profile for an advertisement segment at step 68. At step 69, the manifest creator determines whether the generated bitrate is below the minimum bitrate threshold for the selected advertisement source. If not, the method moves to step 70 where the manifest creator includes the advertisement from the selected advertisement source in the manifest.

However, when the generated bitrate is below the minimum bitrate threshold for the selected advertisement source at step 69, the method moves to step 71 where the manifest creator selects a different advertisement source with the next lowest minimum bitrate threshold. At step 72, a determination is made as to whether this is the last advertisement source 11n available to the manifest creator (i.e., the advertisement source with the lowest minimum bitrate threshold). If not, the method returns to step 69 and determines whether the generated bitrate is below the minimum bitrate threshold for this next selected advertisement source. This process continues until either an advertisement source is identified that has a minimum bitrate threshold below the generated bitrate or the last advertisement source with the lowest minimum bitrate threshold is checked. Upon the occurrence of either of those two events, the method moves to step 70 and includes the advertisement from the current selected source in the manifest. The method ends when the segment is complete at step 73.

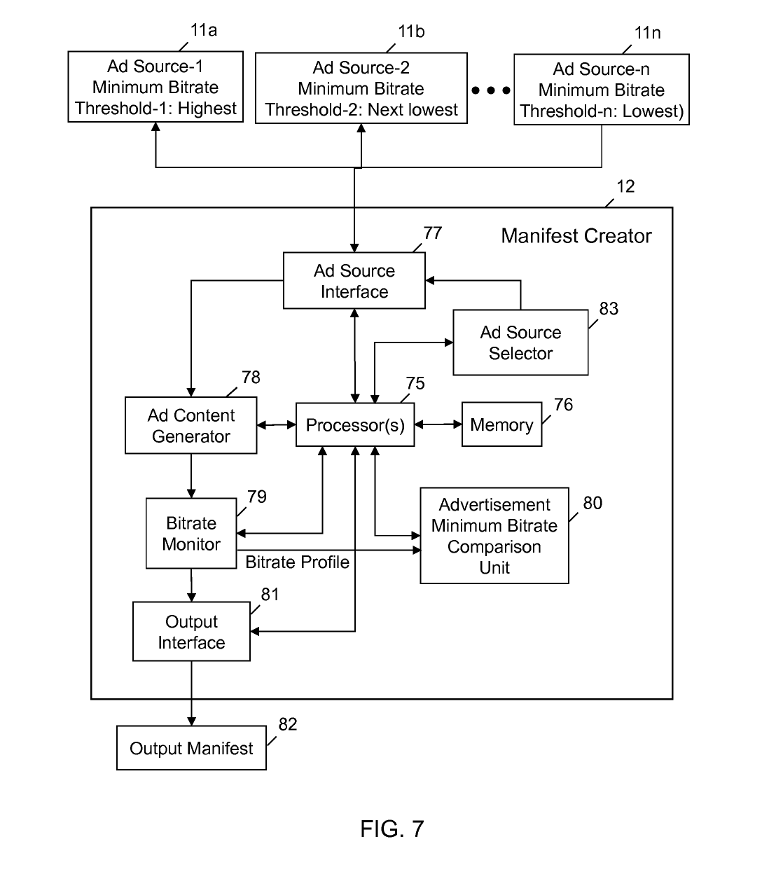

FIG. 7 is a simplified block diagram of an exemplary manifest creator 12 configured to perform the method of FIG. 6. The manifest creator may be controlled by one or more computer processor(s) 75 and a non-transitory memory 76 coupled to the processor, wherein the memory is encoded with one or more programs that perform the method when executed by the processor. An advertisement source interface 77 interfaces with the multiple advertisement sources 11a-11n.

The manifest creator creates a segment for an advertising slot utilizing the multiple sources 11a-11n, each of which provides an advertisement with a different minimum bitrate threshold. Initially, an advertisement from Ad Source-1 11a may be selected and provided by the advertisement source interface 77 to an advertisement content generator 78. The advertisement content generator generates a bitrate profile for an advertisement segment, and a bitrate monitor 79 determines the bitrate for the generated profile and provides the profile to an advertisement minimum bitrate comparison unit 80. The comparison unit determines whether the generated bitrate is below the minimum bitrate threshold for Ad Source-1. If not, the processor 75 causes an output interface 81 to include the advertisement from Ad Source-1 in the output manifest 82.

However, when the comparison unit 80 determines that the generated bitrate is below the minimum bitrate threshold for Ad Source-1, the processor 75 causes an advertisement source selector 83 to select a different advertisement source with the next lowest minimum bitrate threshold (e.g., Ad Source-2). The process of generating the bitrate profile and comparing the generated bitrate to the minimum bitrate threshold for the selected advertisement source (Ad Source-2) is repeated to determine whether the generated bitrate is below the minimum bitrate threshold for Ad Source-2. If the generated bitrate is still below the minimum bitrate threshold for Ad Source-2, the advertisement source selector 83 may select a different advertisement source with the next lowest minimum bitrate threshold. This iterative process continues until either the advertisement source selector selects an advertisement source having a minimum bitrate threshold below the generated bitrate, or the last advertisement source with the lowest minimum bitrate threshold (e.g., Ad Source-n) is checked. Upon the occurrence of either of those two events, the processor 75 causes the output interface 81 to include the advertisement from the currently selected advertisement source in the output manifest 82.

In this way, the manifest creator 12 selects an advertisement having a minimum bitrate threshold higher than the generated bitrate (i.e., a situation adversely affecting the effectiveness of the advertisement) only when there is no other choice (i.e., all of the advertisement sources have been checked and none of them can provide an advertisement with a minimum bitrate threshold below the generated bitrate). In general, the manifest creator will select the advertisement with the best possible quality, given the generated bitrate for the advertisement segment. The generated manifest looks normal to both the advertisement server 13 and the client device 14 and no changes are needed on their part.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method in an advertisement control system for providing adaptive bitrate-dynamic advertisements in a video stream defined by a manifest, wherein adaptive streaming in a delivery network causes a delivery bitrate of the video stream to vary due to changes in delivery network conditions, the method comprising:
monitoring the delivery bitrate of the video stream in the delivery network;
determining whether the delivery bitrate of the video stream has fallen below a minimum bitrate threshold of a next advertisement in the manifest; and
when the delivery bitrate of the video stream has fallen below the minimum bitrate threshold of the next advertisement, replacing the next advertisement in the manifest with a replacement video chunk having a minimum bitrate threshold lower than or equal to the delivery bitrate of the video stream.

2. The method according to claim 1, wherein the method is performed by an advertisement server.

3. The method according to claim 2, wherein the determining step includes determining the minimum bitrate threshold of the next advertisement by reading metadata included with the next advertisement.

4. The method according to claim 2, further comprising, when the delivery bitrate of the video stream has not fallen below the minimum bitrate threshold of the next advertisement, streaming the next advertisement to a client device.

5. The method according to claim 2, wherein the replacement video chunk is a replacement advertisement, and upon determining that the delivery bitrate of the video stream has fallen below the minimum bitrate threshold of the next advertisement, the advertisement server performs the steps of:
attempting to identify a replacement advertisement having a minimum bitrate threshold lower than or equal to the delivery bitrate of the video stream;
when a replacement advertisement having a minimum bitrate threshold lower than or equal to the delivery bitrate of the video stream cannot be identified, streaming the next advertisement to a client device; and
when a replacement advertisement having a minimum bitrate threshold lower than or equal to the delivery bitrate of the video stream can be identified, performing the replacing step with the identified replacement advertisement.

6. The method according to claim 1, wherein the method is performed by a client device.

7. The method according to claim 6, wherein the determining step includes determining the minimum bitrate threshold of the next advertisement by reading metadata included with the next advertisement.

8. The method according to claim 6, wherein the replacing step includes retrieving the replacement video chunk from a local memory in the client device.

9. The method according to claim 8, wherein the replacement video chunk is a replacement advertisement having a bitrate profile of similar quality to the delivery bitrate for consistency of viewing by an end user.

10. The method according to claim 1, wherein the method is performed by a manifest creator.

11. The method according to claim 10, wherein the determining step includes determining the minimum bitrate threshold of the next advertisement by reading metadata included with the next advertisement.

12. The method according to claim 10, wherein the manifest creator obtains advertisements from a plurality of advertisement sources, each advertisement source providing advertisements with different minimum bitrate thresholds, and the next advertisement is provided by a first advertisement source, the replacing step comprising:
selecting a different, second advertisement source that provides advertisements with a lower minimum bitrate threshold than the first advertisement source;
obtaining a replacement advertisement from the second advertisement source; and
including the replacement advertisement from the second advertisement source in the manifest in place of the next advertisement when the replacement advertisement has a minimum bitrate threshold lower than or equal to the delivery bitrate of the video stream.

13. An arrangement in an advertisement control system for providing adaptive bitrate-dynamic advertisements in a video stream defined by a manifest, wherein adaptive streaming in a delivery network causes a delivery bitrate of the video stream to vary due to changes in delivery network conditions, the arrangement comprising:
a bitrate monitor configured to monitor the delivery bitrate of the video stream; and
a processor configured to:
determine whether the delivery bitrate of the video stream has fallen below a minimum bitrate threshold of a next advertisement in the manifest; and
replace the next advertisement in the manifest with a replacement video chunk when the delivery bitrate of the video stream has fallen below the minimum bitrate threshold of the next advertisement, wherein the replacement video chunk has a minimum bitrate threshold lower than or equal to the delivery bitrate of the video stream.

14. The arrangement according to claim 13, wherein the arrangement is implemented in an advertisement server.

15. The arrangement according to claim 14, wherein the processor is configured to determine the minimum bitrate threshold of the next advertisement by reading metadata included with the next advertisement.

16. The arrangement according to claim 14, wherein an output interface is configured to stream the next advertisement to a client device, when the delivery bitrate of the video stream has not fallen below the minimum bitrate threshold of the next advertisement.

17. The arrangement according to claim 14, wherein the replacement video chunk is a replacement advertisement, and upon determining that the delivery bitrate of the video stream has fallen below the minimum bitrate threshold of the next advertisement, the advertisement server is configured to:
attempt to identify a replacement advertisement having a minimum bitrate threshold lower than or equal to the delivery bitrate of the video stream;
when a replacement advertisement having a minimum bitrate threshold lower than or equal to the delivery bitrate of the video stream cannot be identified, stream the next advertisement to a client device; and
when a replacement advertisement having a minimum bitrate threshold lower than or equal to the delivery bitrate of the video stream can be identified, replace the next advertisement in the manifest with the identified replacement advertisement.

18. The arrangement according to claim 13, wherein the arrangement is implemented in a client device.

19. The arrangement according to claim 18, wherein the processor is configured to determine the minimum bitrate threshold of the next advertisement by reading metadata included with the next advertisement.

20. The arrangement according to claim 18, wherein the processor is configured to retrieve the replacement video chunk from a local memory in the client device.

21. The arrangement according to claim 20, wherein the replacement video chunk is a replacement advertisement having a bitrate profile of similar quality to the delivery bitrate for consistency of viewing by an end user.

22. The arrangement according to claim 13, wherein the arrangement is implemented in a manifest creator.

23. The arrangement according to claim 22, wherein the processor is configured to determine the minimum bitrate threshold of the next advertisement by reading metadata included with the next advertisement.

24. The arrangement according to claim 22, wherein the manifest creator obtains advertisements from a plurality of advertisement sources, each advertisement source providing advertisements with different minimum bitrate thresholds, and the next advertisement is provided by a first advertisement source, wherein the processor is configured to control the following components to replace the next advertisement in the manifest:
an advertisement source selector configured to select a different, second advertisement source that provides advertisements with a lower minimum bitrate threshold than the first advertisement source;
an advertisement source interface configured to obtain a replacement advertisement from the second advertisement source; and
an output interface configured to replace the next advertisement in the manifest with the replacement advertisement from the second advertisement source when the replacement advertisement has a minimum bitrate threshold lower than or equal to the delivery bitrate of the video stream.
